(19) United States
(12) Patent Application Publication
(10) Pub. No.: US 2016/0030789 A1
(43) Pub. Date: Feb. 4, 2016

(54) COLORIZED FIRE EXTINGUISHING COMPOSITIONS

(71) Applicant: GeITech Solutions, Inc., Jupiter, FL (US)

(72) Inventor: Peter Cordani, Palm Beach Gardens, FL (US)

(21) Appl. No.: 14/731,458

(22) Filed: Jun. 5, 2015

Related U.S. Application Data
(60) Provisional application No. 62/008,525, filed on Jun. 6, 2014.

(51) Int. Cl. A62D 1/00

(52) U.S. Cl. CPC A62D 1/0014

(57) ABSTRACT

Fire extinguishing compositions and formulations include super absorbent aqueous based biodegradable polymers. Colorants and colorant formulations provide visibility from a distance when the fire extinguishing composition is discharged. The colorants progressively fade so as to mitigate environmental impact. Methods of producing the fire extinguishing compositions and formulations are provided.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 62/008,525, filed Jun. 6, 2014, the contents of which are incorporated herein by reference.

### FIELD OF THE INVENTION

Embodiments of the invention are directed to fire extinguishing compositions for the suppression and extinguishing of fires. In particular embodiments, the fire extinguishing compositions are colored for visibility.

### BACKGROUND

Fire retardant solutions used to combat and control wild fires are applied from the ground or from the air. Application from the ground is usually from a vehicle such as a fire engine, while application from the air is usually from an airplane or helicopter. A variety of fire retardant solutions are known. “Evaluation of Megatard 2700: A Proposed New Fire Retardant System”, C. W. George and C. W. Johnson, U.S.D.A. Forest Service, Intermountain Forest and Range Experimental Station, General Technical Report INT-112, August 1981, describes a fire retardant system containing ammonium sulfate as the active fire retardant salt, a guar gum thickener, iron oxide as a colorant, a spoilage inhibitor, and corrosion inhibitors. In this case, the fire retardant composition is prepared by mixing ammonium sulfate and corrosion inhibitor to form a liquid component. The iron oxide, thickener, and spoilage inhibitor are mixed with water to form a slurry. The slurry and the liquid component are then mixed in equal volumes to form the mixed fire retardant, which is then loaded into an aircraft or ground engine, transported to, and applied to retard a wildland fire.

Phosphate solutions useful for fire-retardant compositions are described in U.S. Pat. Nos. 3,223,649, 3,257,316, 3,275,566, 3,293,189, 3,338,829, 3,342,749, 3,350,305, 3,364,149, and 3,634,234. Other fire-retardant compositions containing various ammonium salts are described in U.S. Pat. Nos. 3,309,324, 4,101,485, 4,145,296, and 4,272,414. Fire retardant compositions stabilized with galactomannan gum are described in U.S. Pat. Nos. 4,447,336, 4,447,337, and 4,606,831.

U.S. Pat. No. 4,168,239 describes thixotropic emulsion concentrates, used to form fire suppressant foams for fire fighting, that contain oil, emulsifier, colorant, and a super absorbent, aqueous fire suppressant. U.S. Pat. No. 3,730,890 describes flame retardant concentrates formed from attapuglite clay suspended in liquid ammonium polyphosphate. U.S. Pat. No. 3,960,735 describes flame retardant polyphosphate compositions containing iron cyanide blue added to inhibit the corrosion of aluminum.

U.S. Pat. No. 3,409,550 describes fire retardant compositions containing a mixture of ammonium sulfate and diammonium phosphate in a super absorbent, aqueous gel. Dyes such as Rhodamine B, azo red A, naphthol orange, and pigments may be added as a marking agent. U.S. Pat. Nos. 4,839,065, 4,971,728, and 4,983,326 describe a fire retardant concentrate containing a thickening agent and a fire retardant. The diammonium phosphate, diammonium sulfate, and monoammonium phosphate blended with polyammonium phosphate are used as the fire retardant.

U.S. Pat. No. 6,675,858 describes aqueous colorized fire retardants containing an uncolored or minimally colored fire retardant and an aqueous colorant which are mixed at a time proximate to discharging the retardant onto the fire.

U.S. Pat. No. 6,447,697 describes a colorized fire retardant composition of a fire retardant and an aqueous dispersion of a pigment formed by polymerizing at least one monomer in the presence of a dye.

### SUMMARY OF THE INVENTION

Embodiments of the invention are directed to fire extinguishing compositions and formulations. In particular embodiments, the fire extinguishing compositions comprise colorants to provide visibility from a distance when the fire extinguishing composition has been discharged onto a fire.

Accordingly, it is an objective of the present invention to provide colorized fire extinguishing compositions and formulations for extinguishing of fires, suppression and retardation of fires and preventing spreading of the fires.

It is a further objective of the present invention to provide colorant formulations for the colorizing of fire extinguishing compositions.

It is still another objective to provide methods of colorizing fire extinguishing compositions.

Other objectives and further advantages and benefits associated with this invention will be apparent to those skilled in the art from the description, examples and claims which follow.

### DETAILED DESCRIPTION

The following description of the preferred embodiments is merely exemplary in nature and is in no way intended to limit the invention, its application or uses. It should be understood that numerous specific details, relationships, and methods are set forth to provide a full understanding of the invention. One having ordinary skill in the relevant art, however, will readily recognize that the invention can be practiced without one or more of the specific details or with other methods. The present invention is not limited by the illustrated ordering of acts or events, as some acts may occur in different orders and/or concurrently with other acts or events. Furthermore, not all illustrated acts or events are required to implement a methodology in accordance with the present invention.

Embodiments of the invention may be practiced without the theoretical aspects presented. Moreover, the theoretical aspects are presented with the understanding that Applicants do not seek to be bound by the theory presented.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### DEFINITIONS

The terminology used herein is for the purpose of describing particular embodiments only and is not intended to be limiting of the invention. Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

As used in this specification and the appended claims, the term “or” is generally employed in its sense including “and/or” unless the content clearly dictates otherwise.

The term “about” or “approximately” means within an acceptable error range for the particular value as determined by one of ordinary skill in the art, which will depend in part on how the value is measured or determined, i.e., the limitations of the measurement system. For example, “about” can mean within or more than 1 standard deviation, per the practice in the art. Alternatively, “about” can mean a range of up to 20%, or up to 10%, or up to 5%, or up to 1% of a given value. Alternatively, the term can mean within an order of magnitude of up to 5-fold of a value. Where particular values are described in the application and claims, unless otherwise stated the term “about” meaning within an acceptable error range for the particular value should be assumed.

As used herein, the term “fire extinguishing” is meant to include the extinguishing of a fire, suppression of a fire, prevention of a fire, protection against a fire, retardation and spreading of a fire.

As used herein, a “fire extinguishing composition” is meant to be inclusive of all components of the composition. Besides the fire extinguishing super absorbent polymer(s) embodied herein, other components and additives may be included in the composition. In some embodiments, the fire extinguishing composition may comprise one or common components of fire retardant formulations, such as: fire retardant salts, conventional fire retardants, corrosion inhibitors, spoilage inhibitors, foaming agents, non foaming agents, flow conditioners, stability additives, thickening agents, conventional fire retardants or the like.

As used herein, “colorant(s)” are chemical substances added to materials to produce color effects. The term “colorant(s)”, besides referring to a single chemical substance which produces a color effect, also includes combinations of colored substances to produce a desired color, and encompasses opaque or opacifier substances e.g. titanium dioxide, and encompasses fugitive and non-fugitive agents or combinations thereof. Accordingly, a fugitive colorant comprises at least one fugitive agent. A non-fugitive colorant comprises at least one non-fugitive agent.

As used herein, a “fugitive” agent is a dye or combination of dyes which fade over time and under ambient field conditions to a colorless or less highly colored hue. A number of such dyes and pigments are well-known in the art. For example, many water soluble dyes fade rapidly. The so-called fluorescent pigments, which are fluorescent dyes encapsulated in a resin integument, are suspendable in the fire extinguishing compositions and also fade rapidly. Examples of these dyes are Basic red I dye, encapsulated dye pigments (available, for example, day-Glo Color Corp., Cleveland, Ohio).

As used herein, a “non-fugitive” agent is a dye or combination of dyes which are insoluble in the carrier liquid, and which, if colored do not necessarily fade after application of the fire extinguishing composition.

As used herein, “opacity” is defined as the ability of matter to obstruct the transmission of radiant energy or light.

### Fire Extinguishing Compositions

Commercial superabsorbent polymers (SAP) are crosslinked networks of ionic polymers capable of absorbing large amounts of water and retaining the absorbed water under pressure. SAPs based on polymers and copolymers of acrylic acid were developed for commercial use in the late 1970s and have since replaced cellulosic or fiber-based products-tissue paper, cotton, sponge, and fluff pulp-in many absorbency applications. The water retention capacity of these fiber-based products is about 20 times their weight at most, more often about 12 times their weight. Additionally, the fiber-based absorbents notoriously release the absorbed water when pressure is applied to the swollen fibers. In contrast, acrylic-based SAP absorb more than 20 times their weight of deionized or distilled water. A comprehensive survey of superabsorbent polymers, and their use and manufacture, is given in F. L. Buchholz and A. T. Graham (editors) in “Modern Superabsorbent Polymer Technology,” Wiley-VCH, New York, 1998. The main industrial uses of commercial SAPs are as absorbents in personal disposable hygiene products, such as baby diapers, adult protective underwear and sanitary napkins.

Currently, the most common SAP employed industrially is sodium polyacrylate (polyacrylic acid, sodium salt), typically crosslinked with a diacrylate or bisacrylamide, such as N,N′-methylene-bisacrylamide. Various copolymers of acrylamide and ethylene maleic anhydride are also employed as SAPs, as well as crosslinked carboxymethyl cellulose, starch, polyacrylate-polyvinyl alcohol copolymers, and polyethylene oxide. Similarly, the acrylic-type monomer itaconic acid is known be useful for making hydrogel-forming polymers. However, sections of polymeric polyelectrolyte chains including a preponderance of repeat units derived from polymerization of acrylic-type monomers (e.g. acrylic acid, acrylamide, itaconic acid and their salts) are not biodegradable and thus are persistent in the environment. Further, when acrylic copolymers and grafts are used in conjunction with degradable polymer materials, only the non-acrylic polymer segments have been conclusively demonstrated to undergo biodegradation.

The advantages of the super absorbent polymers embodied herein, are: highly water absorbent and have high water retention capacities, are non-toxic, are aqueous based and are biodegradable. The combinations of these properties make the super absorbent polymers embodied herein, as ideal for use combating fires and are applicable in any fire situation from residential to industrial and environmental fires.

In general embodiments, a fire extinguishing composition comprises a super absorbent polymer in amounts to effectively extinguish, suppress and prevent the spread of fire. In preferred embodiments, the fire extinguishing composition comprises a biodegradable, super absorbent, aqueous based polymer. Examples of these polymers are: cross-linked modified polyacrylamides/potassium acrylate or polyacrylamides/sodium acrylate. Other suitable polymers include, albeit not limited to, carboxy-methylcellulose, alginic acid, cross-linked starches, and cross-linked polyamino acids. In some preferred embodiments, the fire extinguishing composition is a dry powder or dry granules. In other embodiments, the composition is hydrated. The hydrated composition may be a liquid, slurry, sludge, gel, foam or any form depending on the amount of water or other liquids added to the composition.

In one preferred embodiment, a fire extinguishing composition comprises a solid form of the super absorbent polymer in an amount effective to extinguish and suppress fire. In preferred embodiments, the super absorbent aqueous based polymer is present in a percent dry weight from about 10% to about 90% of total dry weight of the composition. In preferred embodiments, the super absorbent polymer is in a dry form, such as, for example, powder, granules, etc. In some embodiments, the particle size of the super absorbent polymer is between about 0.001 microns to about 300 microns in diameter. In some preferred embodiments, the particle size of the super absorbent polymer is about 50 microns in diameter. In other embodiments, the particle size of the super absorbent polymer is about 100 microns. The dry super absorbent polymer can be added to a given volume of water to form solutions, gels, slurries etc., of the fire extinguishing compositions embodied herein.

In another embodiment, a fire extinguishing composition comprises a super absorbent aqueous based polymer, wherein the aqueous based polymer is present in the composition from about 10% dry weight to about 95% dry weight. In some instance it may be desired to have a fire extinguishing composition that is not colored. Accordingly, in some embodiments, the fire extinguishing composition optionally comprises a colorant present in the composition from about 10% dry weight to about 90% dry weight; an opacifier or opacifier blend is present in the composition from about 10% dry weight to about 60% dry weight. In some embodiments, one or more additives may be included.

In many cases, the fire extinguishing composition is used to combat and prevent the spread of wild land fires. The fire extinguishing composition is applied directly to the burning vegetation to extinguish, suppress, retard and prevent the further spreading of the fire. Additionally, the fire extinguishing composition can be applied to threatened vegetation ahead of an approaching wild land fire for containment of the fire. It is often desirable to mark the locations where the fire extinguishing compositions have been applied in order to coordinate fire-fighting activities, conserve supplies, and show the progress of the fire-fighting effort. The fuel that feeds a wild land fire varies widely from grasses to large trees. Therefore, the color pigment in the applied fire extinguishing must present an adequate color contrast from the background fuel to conveniently show where the composition has been applied.

Accordingly, the fire extinguishing composition comprises one or more colorants. The colorants can include dyes and pigments which degrade or lose their color over time, e.g. fugitive components. The colorants can be chosen based on the rate of color loss and biodegradability in order to minimize the environmental impact of the fire extinguishing composition. In some embodiments, the colorant comprises a fugitive agent, a non-fugitive agent or combinations thereof.

In some preferred embodiments, a fire extinguishing composition comprises a super absorbent, aqueous based polymer, a colorant, an opacifier or an opacifier blend in an amount to effectively colorize the fire extinguishing composition.

In preferred embodiments, a colorant is selected for visibility and for the rate of degradation. For example, if the fire is a wild land fire and the terrain is mainly green, a blue or red colorant can be chosen. Due to environmental concerns, it is preferred that the color fades after a few days. Examples of colorants, include, without limitation: aniline black; anthraquinone black; carbon black; copper carbonate; graphite; iron oxide; micaceous iron oxide; manganese dioxide, azo condensation, metal complex brown; antimony oxide; basic lead carbonate; lithopone; titanium dioxide; white lead; zinc oxide; zinc sulfide; titanium dioxide, ferric oxide covered mica; bismuth oxychloride crystal; dioxazine violet; carbazole blue; cobalt blue; indanthrone; phthalocyanine blue; Prussian blue; ultramarine; chrome green; hydrated chromium oxide; phthalocyanine green; anthrapyrimidine; arylamide yellow; barium chromate; benzimidazolone yellow; bismuth vanadate; cadmium sulfide yellow; complex inorganic color; diarylide yellow; disazo condensation; flavanthrone; isoindoline; isoindolinone; lead chromate; nickel azo yellow; organic metal complex; yellow iron oxide; zinc chromate; perinone orange; pyrazolone orange; anthraquinone; benzimidazolone; BON arylamide; cadmium red; cadmium selenide; chrome red; dibromanthrone; diketopyrrolo-pyrrole; lead molybdate; perylene; pyranthrone; quinacridone; quinophthalone; red iron oxide; red lead; toluidine red; β-naphthol red; aluminum flake; aluminum non-leafing, gold bronze flake; zinc dust; stainless steel flake; nickel flake; nickel powder; barium ferrite; borosilicate; burnt sienna; burnt umber; calcium ferrite; cerium; chrome orange; chrome yellow; chromium phosphate; cobalt-containing iron oxide; fast chrome green; gold bronze powder; luminescent; magnetic; molybdate orange; molybdate red; oxazine; oxysulfide; polycyclic; raw sienna; surface modified pigment; thiazine; thioindigo; transparent cobalt blue; transparent cobalt green; transparent iron blue; transparent zinc oxide; triarylcarbonium; zinc cyanamide; zinc ferrite; or a combination thereof.

In some embodiments, a fire extinguishing composition comprises a colorant in a percent dry weight from about 10% to about 90% of total weight of the composition. In some embodiments, the colorant comprises a fugitive agent, a non-fugitive agent, an opacifier, an opacifier blend or combinations thereof.

In one embodiment, the colorant is blue cobalt. In another embodiment, the colorant is red iron oxide or red dye.

Embodiments of the invention are also directed to the use of opacifiers or opacifying agents as components of the fire extinguishing compositions. In some embodiments, an opacifier comprises titanium dioxide, red iron oxide, iron oxides, iron phosphates, potassium titanate, lead salts, antimony oxide, zinc borate, zinc oxide, zinc sulfide, zirconium oxide, zirconium silicate, tin oxide, rutile, cassiterite or mixtures thereof. In one preferred embodiment, the opacifiers comprise titanium dioxide or red iron oxide. In other embodiments, the opacifiers can be utilized as a colorant or a component of a colorized blend.

In some preferred embodiments, an opacifier comprises titanium dioxide, or red iron oxide. In other embodiments, an opacifier blend comprises an opacifier, gum Arabic, starch and maltodextrin.

In other preferred embodiments, the fire extinguishing composition comprises an opacifier or opacifier blend in a percent dry weight of about 10% to about 60% of total weight of the composition.

Embodiments of the invention are further directed to fire suppressant formulations. In preferred embodiments, a fire suppressant formulation comprises a super absorbent, aqueous based polymer, a colorant, an opacifier, an opacifier blend or combinations thereof. In some preferred embodiments, a fire suppressant formulation comprises a super absorbent aqueous based polymer having a dry weight from about 10 pounds (lbs) to about 80 lbs, a colorant having a dry weight of about 5 lbs to about 40 lbs and an opacifier or opacifier blend having a dry weight from about 2 lbs to about 20 lbs. Preferably, the super absorbent aqueous based polymer comprises cross-linked modified polyacrylamides/potassium acrylate, polyacrylamides/sodium acrylate, carboxy-methylcellulose, alginic acid, cross-linked starches, cross-linked polyaminoacids or combinations thereof. In some embodiments, the colorant comprises blue cobalt, red dye and the opacifier comprises titanium dioxide, iron oxide.

In one preferred embodiment, a fire extinguishing formulation comprises a super absorbent, aqueous based polymer.

In another preferred embodiment, a colored fire extinguishing formulation comprises a super absorbent, aqueous based polymer, a colorant, an opacifier or an opacifier blend in range of ratios by dry weight from about 1:1:1 of the super absorbent aqueous based polymer colorant opacifier or opacifier blend to about 10:1:0.5 of aqueous based polymer:colorant:opacifier or opacifier blend.

In another preferred embodiment, a colored fire extinguishing formulation comprises a super absorbent, aqueous based polymer, a colorant, an opacifier or an opacifier blend in range of ratios by dry weight from about 2:1:0.5 of aqueous based polymer:colorant:opacifier or opacifier blend.

In another preferred embodiment, a colored fire extinguishing formulation consists of a super absorbent, aqueous based polymer and a colorant in range of ratios by dry weight from about 1:1 of the super absorbent aqueous based polymer:colorant to about 10:1 of aqueous based polymer:colorant.

In another preferred embodiment, a colored fire extinguishing formulation consists of a super absorbent, aqueous based polymer and a colorant in a ratio by dry weight from about 2:1 of aqueous based polymer:colorant.

In another preferred embodiment, a colored fire extinguishing formulation consists of a super absorbent, aqueous based polymer and an opacifier or an opacifier blend in range of ratios by dry weight from about 1:1 of the super absorbent aqueous based polymer opacifier or opacifier blend to about 10:0.5 of aqueous based polymer:opacifier or opacifier blend.

In another preferred embodiment, a colored fire extinguishing formulation consists of a super absorbent, aqueous based polymer, an opacifier or an opacifier blend in range of ratios by dry weight from about 2:0.5 of aqueous based polymer:opacifier or opacifier blend.

In other embodiments, the fire extinguishing compositions optionally comprise one or more corrosion inhibitors. Examples include, azoles, soluble or insoluble ferric pyrophosphate, ferrous oxalate, ferric citrate, ferrous sulfate, ferric ammonium citrate, soluble or insoluble ferric orthophosphate, ferric ammonium oxalate, ferric ammonium sulfate, ferric bromide, ferric sodium oxalate, ferric stearate, ferric sulfate, ferrous acetate, ferrous ammonium sulfate, ferrous bromide, ferrous gluconate, ferrous iodide, ferric acetate, ferric fluoroborate, ferric hydroxide, ferric oleate, ferrous fumarate, ferrous oxalate, ferrous oxide, ferrous lactate, ferric resinate or any combination thereof. In some embodiments, the fire extinguishing compositions comprise from about 0.0001% to about 20% by weight of corrosion inhibitors or 0.0001% to 20% vol/vol. of the total volume of the fire extinguishing composition when using liquid formulations or liquids.

In other embodiments, the corrosion inhibitors in the formulations and compositions embodied herein, are added in amounts as determined by the Uniform Corrosion Test as set forth in the Standard Test Procedures, Section 5, STP 5.1 (USDA Forest Service, Wildland Fire Chemical Systems).

Embodiments are also directed to colored fire retardant or fire suppressant formulations. In preferred embodiments, a colored fire retardant or fire suppressant formulation comprises a super absorbent, aqueous based polymer, a colorant, an opacifier or an opacifier blend wherein the aqueous based polymer is present in the composition from about 10% dry weight to about 95% dry weight; the colorant is present in the composition from about 10% dry weight to about 90% dry weight; the opacifier or opacifier blend is present in the composition from about 10% dry weight to about 60% dry weight.

The fire retardant or fire suppressant formulations optionally comprise one or more conventional additives added in the industry conventional amounts. Examples include viscosity agents, fillers, pigments, dyes, impact modifiers, U.V. stabilizers, biopolymers (e.g. guar gum, alginate and gelatin) antioxidants, processing aids, nucleating agents, lubricants, surfactants, corrosion inhibitors and the like.

Embodiments are also directed to methods of producing colored fire extinguishing compositions. In one preferred embodiment, a method of producing a colored fire extinguishing comprises mixing a fire extinguishing composition comprising a super absorbent, aqueous based polymer, a colorant, an opacifier or an opacifier blend in an amount to effectively colorize the fire extinguishing composition.

In one embodiment, a super absorbent aqueous based polymer is added in a percent dry weight from about 10% to about 95% of total weight of the composition; a colorant is added in a percent dry weight from about 10% to about 90% of total weight of the composition; and, an opacifier or opacifier blend is present in a percent dry weight of about 10% to about 60% of total weight of the composition.

Embodiments of the invention are also directed to colorized formulations or colorants to provide visibility to fire extinguishing compositions. In some embodiments, a colorant for adding to a fire extinguishing composition comprises blue cobalt, titanium dioxide, red iron oxide or combinations thereof. In one preferred embodiment, the percent dry weight of blue cobalt is from about 10% to about 90% of the total dry weight of the colorant and the titanium dioxide or red iron oxide is from about 10% to about 90% of the total dry weight of the colorant.

In some embodiments, the fire extinguishing composition optionally comprises one or more conventional additives added in the industry conventional amounts. Examples include viscosity agents, fillers, pigments, dyes, impact modifiers, U.V. stabilizers, biopolymers (e.g. guar gum, alginate and gelatin) antioxidants, processing aids, nucleating agents, lubricants, surfactants, corrosion inhibitors and the like. In some embodiments, the fire extinguishing composition comprises one or more additives up to 10% dry weight.

In other embodiments, the fire extinguishing compositions may comprise one or more additives wherein the additive is a conventional flame extinguishing. These include, for example, brominated compounds, phosphorous compounds, organophosphorous compounds, chlorinated compounds, tin compounds, alumina hydrates, inorganic polyphosphates, metal polyphosphates, borates and antimony oxides.

Other examples of conventional fire retardants include, without limitation: monoammonium orthophosphate, diammonium orthophosphate, monoammonium pyrophosphate, diammonium pyrophosphate, triammonium pyrophosphate, tetraammonium pyrophosphate, ammonium polyphosphate, substituted ammonium polyphosphate, amide polyphosphate, melamine polyphosphate, ammonium-alkali metal mixed salts of orthophosphate, ammonium-alkali metal mixed salts of pyrophosphate, ammonium-alkali metal mixed salts of polyphosphate, ammonium-alkaline earth metal mixed salts of orthophosphate, ammonium-alkaline earth metal mixed salts of pyrophosphate, ammonium-alkaline earth metal mixed salts of polyphosphate, ammonium sulfate, liquid ammonium polyphosphates and blends thereof. Ammonium polyphospohate is often called polyammonium phosphate, and commonly contains other ammonium phosphate such as pyro and metaphophates, and the alkali metal equivalents thereof, as well as a blend of phosphate polymers. Such polyammonium phosphates are often referred to as 10-34-0, 11-37-0, 12-40-0, 13-42-0 or the like, where the first number indicates the percentage of nitrogen in the blend, the middle number indicates the percentage phosphate in the blend and the last number indicates the percentage potash in the blend.

In some embodiments, the conventional fire retardant comprises penta-bromodiphenyl ether, octa-bromodiphenyl ether, deca-bromodiphenyl ether, short-chain chlorinated paraffins (SCCPs), medium-chain chlorinated paraffins (MCCPs), hexabromocyclododecane (HBCD), tetrabromobisphenol A (TBBPA), tetrabromobisphenol A ether, pentabromotoluene, 2,3-dibromopropyl-2,4,6-tribromophenyl ether, tetrabromobisphenol A, bis(2,3-dibromopropyl ether), tris(tribromophenoxy)triazine, tris(2-chloroethyl)phosphate (TCEP), tris(2-chloro-1-methylethyl)phosphate (TCPP or TMCP), tris(1,2-dichloropropyl)phosphate (TDCP), 2,2-bis(chloromethyl)-trimethylene bis(bis(2-chloroethyl)phosphate), melamine cyanurate, antimony trioxide Sb₂O₃ (ATO), boric acid, ammonium polyphosphate (APP), aluminum ammonium polyphosphate, aluminum hydroxide, magnesium hydroxide red phosphorous, 1,2-bis(tribromophenoxy)ethane, 2,4,6-tribromophenyl glycidyl ether, tetrabromo phthalic anhydride, 1,2-bis(tetrabromo phthalimide) ethane, tetrabromo dimethyl phthalate, tetrabromo disodium phthalate, decabromodiphenyl ether, tetradecabromodi(phenoxyl)benzene, 1,2-bis(pentabromophenyl) ethane, bromo-trimethyl-phenyl-hydroindene, pentabromobenzyl acrylate, pentabromobenzyl bromide, hexabromobenzene, pentabromotoluene, 2,4,6-tribromophenyl maleimide, hexabromo cyclododecane, N,N′-1,2-bis(dibromonorbornyl dicarbimide) ethane, pentabromochloro-cyclohexane, tri(2,3-dibromopropyl) isocyanurate, bromo-styrene copolymer, tetrabromobisphenol A-carbonate oligomer, polypentabromobenzyl acrylate, polydibromophenylene ether; chlorinated flame retardants such as dechlorane plus, HET anhydride (chlorendic anhydride), perchloro pentacyclodecane, tetrachloro bisphenol A, tetrachlorophthalic anhydride, hexachlorobenzene, chlorinated polypropylene, chlorinated polyvinyl chloride, vinyl chloride-vinylidene chloride copolymer, chlorinated polyether, hexachloroethane; organic phosphorus flame retardants such as 1-oxo-4-hydroxymethyl-2,6,7-trioxa-1-phosphabicyclo[2,2,2]octane, 2,2-dimethyl-1,3-propanediol-di(neopentyl glycol)diphosphate, 9,10-dihydro-9-oxa-10-phosphaphenanthrene-10 oxide, bis(4-carboxyphenyl)-phenyl phosphine oxide, bis(4-hydroxyphenyl)-phenyl phosphine oxide, phenyl(diphenyl sulfone) phosphate oligomer; phosphorus-halogenated flame retardants such as tris(2,2-di(bromomethyl)-3-bromopropyl)phosphate, tris(dibromophenyl)phosphate, 3,9-bis(tribromophenoxy)-2,4,8,10-tetraoxa-3,9-diphosphaspiro[5,5]-3,9-di-oxo-undecane, 3,9-bis(pentabromophenoxy)-2,4,8,10-tetraoxa-3,9-diphosphaspiro[5,5]-3,9-dioxo-undecane, 1-oxo-4-tribromophenoxycarbonyl-2,6,7-trioxa-1-phosphabicyclo[2,2,2]octan-e, p-phenylene-tetrakis(2,4,6-tribromophenyl)-diphosphate, 2,2-di(chloromethyl)-1,3-propanediol-di(neopentyl glycol)diphosphate, 2,9-di(tribromo-neopentyloxy)-2,4,8,10-tetraoxa-3,9-diphosphaspiro[5,5]-3-,9-dioxo-undecane; nitrogen-based flame retardants or phosphorus-nitrogen-based flame retardants such as melamine, melamine cyanurate, melamine orthophosphate, dimelamine orthophosphate, melamine polyphosphate, melamine borate, melamine octamolybdate, cyanuric acid, tris(hydroxyethyl)isocyanurate, 2,4-diamino-6-(3,3,3-trichloro-propyl)-1,3,5-triazine, 2,4-di(N-hydroxymethyl-amino)-6-(3,3,3-trichloro-propyl-1,3,5-triazine), diguanidine hydrophosphate, guanidine dihydrogen phosphate, guanidine carbonate, guanidine sulfamate, urea, urea dihydrogen phosphate, dicyandiamide, melamine bis(2,6,7-trioxa-phospha-bicyclo[2.2.2]octane-1-oxo-4-methyl)-hydroxy-phosphate, 3,9-dihydroxy-3,9-dioxo-2,4,8,10-tetraoxa-3,9-diphosphaspiro[5.5]u-ndecane-3,9-dimelamine, 1,2-di(2-oxo-5,5-dimethyl-1,3-dioxa-2-phosphacyclohexyl-2-amino) ethane, N,N′-bis(2-oxo-5,5-dimethyl-1,3-dioxa-2-phosphacyclohexyl)-2,2′-m-phenyle-nediamine, tri(2-oxo-5,5-dimethyl-1,3-dioxa-2-phosphacyclohexyl-2-methyl)a-mine, hexachlorocyclotriphosphazene; and inorganic flame retardants such as red phosphorus, ammonium polyphosphate, diammonium hydrophosphate, ammonium dihydrogen phosphate, zinc phosphate, aluminum phosphate, boron phosphate, antimony trioxide, aluminum hydroxide, magnesium hydroxide, hydromagnesite, alkaline aluminum oxalate, zinc borate, barium metaborate, zinc oxide, zinc sulfide, zinc sulfate heptahydrate, aluminum borate whisker, ammonium octamolybdate, ammonium heptamolybdate, zinc stannate, stannous oxide, stannic oxide, ferrocenc, ferric acetone, ferric oxide, ferro-ferric oxide, ammonium bromide, sodium tungstate, potassium hexafluorotitanate, potassium hexafluorozirconate, titanium dioxide, calcium carbonate, barium sulfate, sodium bicarbonate, potassium bicarbonate, cobalt carbonate, zinc carbonate, basic zinc carbonate, heavy magnesium carbonate, basic magnesium carbonate, manganese carbonate, ferrous carbonate, strontium carbonate, sodium potassium carbonate hexahydrate, magnesium carbonate, calcium carbonate, dolomite, basic copper carbonate, zirconium carbonate, beryllium carbonate, sodium sesquicarbonate, cerium carbonate, lanthanum carbonate, guanidine carbonate, lithium carbonate, scandium carbonate, vanadium carbonate, chromium carbonate, nickel carbonate, yttrium carbonate, silver carbonate, praseodymium carbonate, neodymium carbonate, samarium carbonate, europium carbonate, gadolinium carbonate, terbium carbonate, dysprosium carbonate, holmium carbonate, erbium carbonate, thulium carbonate, ytterbium carbonate, lutetium carbonate, aluminum diacetate, calcium acetate, sodium bitartrate, sodium acetate, potassium acetate, zinc acetate, strontium acetate, nickel acetate, copper acetate, sodium oxalate, potassium oxalate, ammonium oxalate, nickel oxalate, manganese oxalate dihydrate, iron nitride, sodium nitrate, magnesium nitrate, potassium nitrate, zirconium nitrate, calcium dihydrogen phosphate, sodium dihydrogen phosphate, sodium dihydrogen phosphate dihydrate, potassium dihydrogen phosphate, aluminum dihydrogen phosphate, ammonium dihydrogen phosphate, zinc dihydrogen phosphate, manganese dihydrogen phosphate, magnesium dihydrogen phosphate, disodium hydrogen phosphate, diammonium hydrogen phosphate, calcium hydrogen phosphate, magnesium hydrogen phosphate, ammonium phosphate, magnesium ammonium phosphate, ammonium polyphosphate, potassium metaphosphate, potassium tripolyphosphate, sodium trimetaphosphate, ammonium hypophosphite, ammonium dihydrogen phosphite, manganese phosphate, dizinc hydrogen phosphate, dimanganese hydrogen phosphate, guanidine phosphate, melamine phosphate, urea phosphate, strontium dimetaborate hydrogen phosphate, boric acid, ammonium pentaborate, potassium tetraborate octahydrate, magnesium metaborate octahydrate, ammonium tetraborate tetrahydrate, strontium metaborate, strontium tetraborate, strontium tetraborate tetrahydrate, sodium tetraborate decahydrate, manganese borate, zinc borate, ammonium fluoroborate, ammonium ferrous sulfate, aluminum sulfate, potassium aluminum sulfate, ammonium aluminum sulfate, ammonium sulfate, magnesium hydrogen sulfate, aluminum hydroxide, magnesium hydroxide, iron hydroxide, cobalt hydroxide, bismuth hydroxide, strontium hydroxide, cerium hydroxide, lanthanum hydroxide, molybdenum hydroxide, ammonium molybdate, zinc stannate, magnesium trisilicate, telluric acid, manganese tungstate, manganite, cobaltocene, 5-aminotetrazole, guanidine nitrate, azobisformamide, nylon powder, oxamide, biuret, pentaerythritol, decabromodiphenyl ether, tetrabromo-phthalic anhydride, dibromoneopentyl glycol, potassium citrate, sodium citrate, manganese citrate, magnesium citrate, copper citrate, ammonium citrate, nitroguanidine.

Embodiments of the invention are also directed to methods of preventing, suppressing, retarding, and/or extinguishing fires. In some embodiments, a method for preventing, suppressing, retarding, and/or extinguishing fires comprises applying the compositions embodied herein to a fire or areas which are threatened with a fire, e.g. wildlands, residential, commercial etc. In some embodiments the compositions are applied aerially or via fire-fighting trucks containing the fire extinguishing compositions, fire extinguishers or any other means necessary and available to the firefighting personnel.

### Examples

Table 1 shows the optimal mixture ratio (dry weight; lbs) of colorant and titanium dioxide or titanium dioxide blend.

TABLE 1

| | |
|---|---|
| Fugitive | Non-Fugitive |

| Colorant | TiO₂ | Colorant | TiO₂ |
|---|---|---|---|
| 9 | 4 | 12 | 5 |

Table 2 shows a range of mixtures (lbs dry weight) of colorant and titanium dioxide or titanium dioxide blend.

TABLE 2

| Fugitive | | | Non-Fugitive | | |
|---|---|---|---|---|---|
| Colorant | TiO₂ | Total | Colorant | TiO₂ | Total |
| 8.5 | 3 | 11.5 | 11 | 4.5 | 15.5 |
| 8.6 | 3.1 | 11.7 | 11.1 | 4.6 | 15.7 |
| 8.7 | 3.2 | 11.9 | 11.2 | 4.7 | 15.9 |
| 8.8 | 3.3 | 12.1 | 11.3 | 4.8 | 16.1 |
| 8.9 | 3.4 | 12.3 | 11.4 | 4.9 | 16.3 |
| 9 | 3.5 | 12.5 | 11.5 | 5 | 16.5 |
| 9.1 | 3.6 | 12.7 | 11.6 | 5.1 | 16.7 |
| 9.2 | 3.7 | 12.9 | 11.7 | 5.2 | 16.9 |
| 9.3 | 3.8 | 13.1 | 11.8 | 5.3 | 17.1 |
| 9.4 | 3.9 | 13.3 | 11.9 | 5.4 | 17.3 |
| 9.5 | 4 | 13.5 | 12 | 5.5 | 17.5 |
| 9.6 | 4.1 | 13.7 | 12.1 | 5.6 | 17.7 |
| 9.7 | 4.2 | 13.9 | 12.2 | 5.7 | 17.9 |
| 9.8 | 4.3 | 14.1 | 12.3 | 5.8 | 18.1 |
| 9.9 | 4.4 | 14.3 | 12.4 | 5.9 | 18.3 |
| 10 | 4.5 | 14.5 | 12.5 | 6 | 18.5 |

The invention has been described in detail with reference to preferred embodiments thereof. However, it will be appreciated that those skilled in the art, upon consideration of this disclosure, may make modifications and improvements within the spirit and scope of the invention.

All documents mentioned herein are incorporated herein by reference. All publications and patent documents cited in this application are incorporated by reference for all purposes to the same extent as if each individual publication or patent document were so individually denoted. By their citation of various references in this document.

What is claimed:

1. A fire extinguishing composition comprising a super absorbent aqueous based polymer, a colorant, an opacifier or an opacifier blend.

2. The fire extinguishing composition of claim 1, wherein the super absorbent aqueous based polymer is present in a percent dry weight from about 10% to about 95% of total weight of the composition.

3. The fire extinguishing composition of claim 1, wherein the colorant is present in a percent dry weight from about 10% to about 90% of total weight of the composition.

4. The fire extinguishing composition of claim 1, wherein the opacifier or opacifier blend is present in a percent dry weight of about 10% to about 60% of total weight of the composition.

5. The fire extinguishing composition of claim 1, wherein the super absorbent aqueous based polymer comprises cross-linked modified polyacrylamides/potassium acrylate, polyacrylamides/sodium acrylate, carboxy-methylcellulose, alginic acid, cross-linked starches, cross-linked polyaminoacids or combinations thereof.

6. The fire extinguishing composition of claim 1, wherein the colorant comprises a fugitive agent, a non-fugitive agent or combinations thereof.

7. The fire extinguishing composition of claim 6, wherein the colorant is blue cobalt or red iron oxide.

8. The fire extinguishing of claim 1, wherein an opacifier comprises titanium dioxide, or red iron oxide.

9. The fire extinguishing composition of claim 1, wherein the opacifier blend comprises an opacifier, gum Arabic, starch, maltodextrin or combinations thereof.

10. The fire extinguishing composition of claim 1, optionally comprising one or more additives up to 10% dry weight.

11. The fire extinguishing composition of claim 1, wherein the composition is a dry powder or granules.

12. The fire extinguishing composition of claim 1, wherein the composition is hydrated.

13. A colored fire extinguishing formulation comprising: a super absorbent aqueous based polymer, a colorant, an opacifier or an opacifier blend wherein the aqueous based polymer is present in the composition from about 10% dry weight to about 95% dry weight; the colorant is present in the formulation from about 10% dry weight to about 90% dry weight; the opacifier or opacifier blend is present in the formulation from about 10% dry weight to about 60% dry weight.

14. A colored fire extinguishing formulation comprising a super absorbent aqueous based polymer, a colorant, an opacifier or an opacifier blend in range of ratios by dry weight from about 1:1:1 of aqueous based polymer:colorant:opacifier or opacifier blend to about 10:1:0.5 of aqueous based polymer:colorant:opacifier or opacifier blend.

15. The colored fire extinguishing formulation of claim 14, wherein the super absorbent, aqueous based polymer, a colorant, an opacifier or an opacifier blend are added in range of ratios by dry weight from about 2:1:0.5 of aqueous based polymer:colorant:opacifier or opacifier blend.

16. A colorant composition comprising a fugitive colorant, a non-fugitive colorant, an opacifier, an opacifier blend or combinations thereof.

17. The colorant composition of claim 16, wherein the fugitive colorant comprises at least one fugitive agent, at least one opacifier or opacifier blend, the at least one fugitive agent being present in the composition from about 10% dry weight to about 95% dry weight; the opacifier or opacifier blend being present in the composition from about 10% dry weight to about 60% dry weight.

18. The colorant composition of claim 16, wherein the non-fugitive colorant comprises at least one non-fugitive agent, at least one opacifier or opacifier blend, the at least one non-fugitive agent being present in the composition from about 10% dry weight to about 95% dry weight; the opacifier or opacifier blend being present in the composition from about 10% dry weight to about 60% dry weight.

19. A colorant formulation comprising a fugitive colorant, a non-fugitive colorant, an opacifier, an opacifier blend or combinations thereof.

20. The colorant formulation of claim 19, wherein the fugitive colorant comprises at least one fugitive agent, at least one opacifier or opacifier blend, the at least one fugitive agent being present in the formulation from about 10% dry weight to about 95% dry weight; the opacifier or opacifier blend being present in the formulation from about 10% dry weight to about 60% dry weight.

21. The colorant formulation of claim 19, wherein the non-fugitive colorant comprises at least one non-fugitive agent, at least one opacifier or opacifier blend, the at least one non-fugitive agent being present in the formulation from about 10% dry weight to about 95% dry weight; the opacifier or opacifier blend being present in the formulation from about 10% dry weight to about 60% dry weight.

22. A colorant for adding to a fire extinguishing composition comprising blue cobalt, titanium dioxide, red iron oxide or combinations thereof.

23. The colorant of claim 22, wherein the percent dry weight of blue cobalt is from about 10% to about 95% of the total dry weight of the colorant and the titanium dioxide or red iron oxide is from about 10% to about 90% of the total dry weight of the colorant.

24. A fire suppressant formulation comprising a super absorbent aqueous based polymer, a colorant, an opacifier or an opacifier blend.

25. The fire suppressant formulation of claim 24, wherein the dry weight per three hundred gallons of the fire suppressant formulation comprises: a dry weight of the aqueous based polymer from about 10 lbs to about 80 lbs, a dry weight of the colorant from about 5 lbs to about 40 lbs and a dry weight of the opacifier or opacifier blend from about 2 lbs to about 20 lbs.

26. The fire suppressant formulation of claim 24, wherein the dry weight of the aqueous based polymer is about 25 lbs, the dry weight of the colorant is about 12 lbs and the dry weight of the opacifier or opacifier blend is about 5 lbs.

27. The fire suppressant formulation of claim 24, wherein the colorant comprises a fugitive colorant, a non-fugitive colorant or combinations thereof.

28. The fire suppressant formulation of claim 24, wherein the fugitive colorant comprises a fugitive agent and opacifier or opacifier blend whereby the dry weight of the fugitive agent is from about 5 lbs to about 40 lbs and the dry weight of the opacifier or opacifier blend is from about 2 lbs to about 20 lbs.

29. The fire suppressant formulation of claim 24, wherein the non-fugitive colorant comprises a non-fugitive agent, an opacifier, opacifier blend, or combinations thereof, whereby the dry weight of the non-fugitive agent is from about 5 lbs to about 40 lbs and the dry weight of the opacifier or opacifier blend is from about 2 lbs to about 20 lbs.

30. The fire suppressant formulation of claim 24, wherein the aqueous based polymer comprises cross-linked modified polyacrylamides/potassium acrylate, polyacrylamides/sodium acrylate, carboxy-methylcellulose, alginic acid, cross-linked starches, cross-linked polyaminoacids or combinations thereof.

31. The fire suppressant formulation of claim 24, wherein the colorant comprises blue cobalt or red dye.

32. The fire suppressant formulation of claim 24, wherein the opacifier comprises titanium dioxide or iron oxide.

33. A method of producing a colored fire extinguishing comprising mixing a composition comprising a super absorbent aqueous based polymer, an opacifier, an opacifier blend, a colorant, or combinations thereof, wherein the colorant is present in an amount to effectively colorize the fire extinguishing composition.

34. The method of claim 33, wherein the aqueous based polymer is present in a percent dry weight from about 10% to about 95% of total dry weight of the composition.

35. The method of claim 33, wherein the colorant is present in a percent dry weight from about 10% to about 90% of total dry weight of the composition.

36. The method of claim 33, wherein the colorant comprises a fugitive colorant, a non-fugitive colorant or combinations thereof.

37. The method of claim 36, wherein the fugitive colorant comprises at least one fugitive agent, at least one opacifier or opacifier blend, the at least one fugitive agent being present in the composition from about 10% dry weight to about 95% dry weight; the opacifier or opacifier blend being present in the composition from about 10% dry weight to about 60% dry weight.

38. The method of claim 36, wherein the non-fugitive colorant comprises at least one non-fugitive agent, at least one opacifier or opacifier blend, the at least one non-fugitive agent being present in the composition from about 10% dry weight to about 95% dry weight; the opacifier or opacifier blend being present in the composition from about 10% dry weight to about 60% dry weight.

39. The method of claim 33, wherein the opacifier or opacifier blend is present in a percent dry weight of about 10% to about 60% of total weight of the composition.

40. The method of claim 33, wherein the aqueous based polymer comprises cross-linked modified polyacrylamides/potassium acrylate, polyacrylamides/sodium acrylate, carboxy-methylcellulose, alginic acid, cross-linked starches, cross-linked polyaminoacids or combinations thereof.

41. The method of claim 33, wherein the colorant comprises blue cobalt or red dye.

42. The method of claim 33, wherein the opacifier comprises titanium dioxide or iron oxide.

43. The method of claim 33, wherein the opacifier blend comprises an opacifier, gum Arabic, starch and maltodextrin.

44. A fire extinguishing composition comprising a super absorbent aqueous based polymer.

45. The fire extinguishing composition of claim 44, wherein the super absorbent aqueous based polymer comprises cross-linked modified polyacrylamides/potassium acrylate, polyacrylamides/sodium acrylate, carboxy-methylcellulose, alginic acid, cross-linked starches, cross-linked polyaminoacids or combinations thereof.

46. The fire extinguishing composition of claim 44, wherein the super absorbent aqueous based polymer is a dry powder or granules.

47. The fire extinguishing composition of claim 44, wherein the super absorbent aqueous based polymer is hydrated.

48. A fire extinguishing composition comprising: a super absorbent aqueous based polymer, wherein the aqueous based polymer is present in the composition from about 10% dry weight to about 95% dry weight.

49. The fire extinguishing composition of claim 48, wherein the composition optionally comprises one or more of: a colorant present in the composition from about 10% dry weight to about 90% dry weight; an opacifier or opacifier blend is present in the composition from about 10% dry weight to about 60% dry weight; or one or more additives of up to 10% dry weight.
